(19) United States
(12) Patent Application Publication
(10) Pub. No.: US 2023/0130119 A1
(43) Pub. Date: Apr. 27, 2023

(54) CHEMICAL FILTER ASSEMBLIES

(71) Applicant: Donaldson Company, Inc., Bloomington, MN (US)

(72) Inventors: David D. Lauer, Minneapolis, MN (US); Steve M. Kruger, Lakeville, MN (US); Shane Lawson, Waconia, MN (US); Daniel E. Adamek, Bloomington, MN (US); Davis B. Moravec, Burnsville, MN (US); Anil Suthar, Eden Prairie, MN (US)

(21) Appl. No.: 17/973,657

(22) Filed: Oct. 26, 2022

Related U.S. Application Data
(60) Provisional application No. 63/271,867, filed on Oct. 26, 2021.

(51) Int. Cl. B01D 46/10; B01D 46/52; B01D 46/00; B01D 35/30; B01D 29/58; B01D 29/54

(52) U.S. Cl. CPC B01D 46/103; B01D 46/527; B01D 46/0005; B01D 35/30; B01D 29/58; B01D 29/54; B01D 2239/065

(57) ABSTRACT

A filter assembly has a housing defining an inlet and an outlet. A plurality of chemical filter elements are disposed in the housing and are arranged in a series with respect to fluid flow. A spacing region is between adjacent filter elements in the series. Also disclosed is an assembly having a housing and a first and second chemical filter element. The second chemical filter element is downstream of the first chemical filter element. Each chemical filter element has a sheet of chemical filter material having a first edge and a second edge. A first flow path is defined parallel to a surface of the first sheet extending from its first edge to its second edge. A second flow path is defined parallel to a surface of the second sheet extending from its first edge to its second edge.

### PRIORITY

The present application claims the benefit of U.S. Provisional Application Ser. No. 63/271,867, which was filed on Oct. 26, 2021, and is incorporated by reference in its entirety.

### TECHNOLOGICAL FIELD

The present disclosure is generally related to filter assemblies. More particularly, the present disclosure is related to chemical filter assemblies.

### SUMMARY

Some embodiments of the technology disclosed herein relate to a filter assembly having a housing, a first chemical filter element and a second chemical filter element. The first chemical filter element has a first sheet of a first chemical filter material having a first edge and a second edge. A first filtration flow path is defined parallel to a surface of the first sheet and the first filtration flow path extends from the first edge to the second edge. The second chemical filter element has a second sheet of a second chemical filter material having a first edge and a second edge. A second filtration flow path is defined parallel to a surface of the second sheet. The second filtration flow path extends from the first edge to the second edge. The first chemical filter element and the second chemical filter element are disposed in the housing. The second chemical filter element is positioned downstream of the first chemical filter element.

In some such embodiments, a spacing region is between the first chemical filter element and the second chemical filter element, where the spacing region defines a flow pathway from the first chemical filter element to the second chemical filter element. Additionally or alternatively, the assembly has a particle filter disposed in the spacing region, where the particle filter has particle filtration media and the flow pathway extends through the particle filtration media. Additionally or alternatively, the first chemical filter element further has a stack of a plurality of layers of sheets of the first chemical filter material including the first sheet, wherein the first filtration flow path is defined between adjacent layers in the stack. In some such embodiments, the first chemical filter element has a stack of a plurality of flow channel layers defining the first filtration flow path, where each flow channel layer is disposed between and abuts layers of sheets of the first chemical filter material in the stack.

Additionally or alternatively, the first sheet of the first chemical filter material is in a coiled configuration about a central axis. In some such embodiments, the first chemical filter element further has a flow channel layer abutting the first sheet of the first chemical filter material, where the flow channel layer defines the first filtration flow path, and the flow channel layer is in a coiled configuration about the central axis.

Additionally or alternatively, the first sheet of the first chemical filter material has embossments extending between the first edge and the second edge. Additionally or alternatively, the first sheet of the first chemical filter material has one more holes extending entirely through the first sheet of the first chemical filter material. Additionally or alternatively, the filter assembly has a third chemical filter element with a third sheet of a third chemical filter material having a first edge and a second edge, where a third filtration flow path is defined parallel to a surface of the third sheet and the third filtration flow path extends from the first edge to the second edge. Additionally or alternatively, the filter assembly has a spacing region defining a flow pathway from the second chemical filter element to the third chemical filter element.

Additionally or alternatively, the first chemical filter material has an adsorbent impregnated with a base. Additionally or alternatively, the first chemical filter material comprises an acid impregnated adsorbent. Additionally or alternatively, the second chemical filter material has an acid impregnated adsorbent. Additionally or alternatively, the second chemical filter material has an adsorbent impregnated with a base. Additionally or alternatively, the first edge is opposite the second edge of the first sheet of chemical filter material. Additionally or alternatively, a fourth chemical filter element has a fourth sheet of a fourth chemical filter material having a first edge and a second edge, wherein a fourth filtration flow path is defined parallel to a surface of the fourth sheet and the fourth filtration flow path extends from the first edge to the second edge. Additionally or alternatively, a spacing region defines a flow pathway from the third chemical filter element to the fourth chemical filter element. Additionally or alternatively, the fourth chemical filter material has a mesoporous absorbent.

Additionally or alternatively, the assembly has a fifth chemical filter element having a fifth sheet of a fifth chemical filter material with a first edge and a second edge, where a fifth filtration flow path is defined parallel to a surface of the fifth sheet and the fifth filtration flow path extends from the first edge to the second edge. Additionally or alternatively, the assembly has a spacing region defining a flow pathway from the fourth chemical filter element to the fifth chemical filter element. Additionally or alternatively, the first chemical filter material has a chemisorbent coated substrate.

Some other embodiments disclosed herein relate to a filter assembly having a housing defining an inlet and an outlet, and a plurality of chemical filter elements within the housing arranged in a series with respect to fluid flow from the inlet to the outlet. The assembly has a spacing region between adjacent filter elements in the series.

In some such embodiments each chemical filter element has chemical filter material configured as a sheet having a first edge and a second edge, and each chemical filter element defines a filtration flow path extending parallel to a surface of the sheet and the filtration flow path extends from the first edge to the second edge. Additionally or alternatively, a first chemical filter element of the plurality of chemical filter elements has a flow channel layer defining the filtration flow path, where the flow channel layer abuts the surface of the sheet between the first edge and the second edge. Additionally or alternatively, a first chemical filter element of the plurality of chemical filter elements comprises a stack of a plurality of layers of sheets of chemical filter material, where the filtration flow path is defined between adjacent layers in the stack. In some such embodiments, the first chemical filter element of the plurality of chemical filter elements further has a stack of a plurality of flow channel layers defining the first filtration flow path, wherein each flow channel layer is disposed between and abuts layers of sheets of the first chemical filter material in the stack.

Additionally or alternatively, the sheet of the first chemical filter material is in a coiled configuration about a central axis. Additionally or alternatively, the sheet has embossments extending between the first edge and the second edge. Additionally or alternatively, the sheet of the first chemical filter material has one more holes extending entirely through the sheet. Additionally or alternatively, one or more chemical filter elements is an adsorbent filter element. Additionally or alternatively, at least one of the chemical filter elements has a chemisorbent coated substrate. Additionally or alternatively, a first chemical filter element of the plurality of chemical filter elements has an adsorbent impregnated with a base.

Additionally or alternatively, a second chemical filter element of the plurality of chemical filter elements has an acid impregnated adsorbent, where the second chemical filter element is downstream of the first chemical filter element. Additionally or alternatively, a first chemical filter element of the plurality of chemical filter element has an acid impregnated adsorbent. Additionally or alternatively, a second chemical filter element has an adsorbent impregnated with a base, where the second chemical filter element is downstream of the first chemical filter element. Additionally or alternatively, the plurality of chemical filter elements has a third chemical filter element downstream of the second chemical filter element. Additionally or alternatively, the plurality of chemical filter elements has a fourth chemical filter element having a mesoporous absorbent, where the fourth chemical filter element is downstream of the third chemical filter element. Additionally or alternatively, the plurality of chemical filter elements further has a fifth chemical filter element downstream of the fourth chemical filter element. Additionally or alternatively, the first edge is opposite the second edge of the first sheet of chemical filter material.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a schematic exploded view of an example filter element.

FIG. 2 is a schematic representation of an example filter element.

FIG. 3A is a schematic representation of an example sheet of filter material.

FIG. 3B is a schematic representation of another example sheet of filter material.

FIG. 4 depicts a schematic representation of another example filter element.

FIG. 5 depicts a schematic representation of yet another example filter element.

FIG. 6 depicts a schematic representation of yet another example filter element.

FIG. 7 depicted a schematic representation of yet another example filter element.

FIG. 8 depicts a schematic representation of an example filter assembly.

FIGS. 9A-12B are test results associated with various filter materials and various contaminants.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

The technology disclosed herein relates to systems and assemblies that execute multi-stage chemical filtration. Such systems and assemblies can be advantageous in the context of air filtration and liquid filtration. One particular example environment within which the current technology may be implemented is a fuel cell environment. For example, a chemical filtration system or assembly can be incorporated in an air intake stream to protect a hydrogen cell in a fuel cell from contaminants. Other potential applications of the current technology include industrial processing, automotive applications, purification of post-combustion flue gas streams for petrochemical processes, or air purification in buildings and aircraft.

Some implementations of the current technology selectively remove particular chemical contaminants in different stages. Such a configuration may advantageously prevent some chemical contaminants from negatively interfering with downstream filtration processes, such as by deactivating chemical filter material. Such a configuration may advantageously improve the lifespan of the filter assembly or at least individual filter elements within the filter assembly. The current technology may advantageously enhance the selectively of the filter assembly for removing very small amounts of particular contaminants. In some implementations, the filter assembly incorporates multiple chemical filtration stages in a single filter housing. Such a configuration may advantageously reduce energy consumption and enhance productivity due to a reduced enthalpic gradient required of regenerating one assembly as opposed to two separate units.

### Definitions

An “adsorbent” is defined herein as a material that is configured to form a surface bond with one or more chemical constituents. “Adsorption” is used herein to encompass “physisorption”, which is a physical bond of a chemical constituent, and “chemisorption”, which is a chemical bond resulting from a chemical reaction.

A chemical filter element is a filter element that is configured to remove one or more chemical species from a fluid stream. A chemical filter element includes adsorbent materials and reactive chemicals, such as chemicals selected to react with specific types of contaminants.

A “flow face” is a region defined by media within a filter element through which fluid flows into the media or out of the media.

“Interparticle pore” is used herein to refer to the void space between particles, such as void space between fibers, or other types of particles, forming a sheet.

“Intraparticle pore” is used herein to refer to the opening defined by the surface of a particle, such as an adsorbent fiber, or types of particles other than fibers such as granules or beads.

“Micropores” is used herein to mean pores having diameters of less than

“Mesopores” and “mesoporous” are used herein to refer to pores having diameters ranging from 2 nm to 50 nm.

“Macropores” refers to pores having diameters of greater than 50 nm.

“Particle filtration media” is used herein to refer to a material that is configured to capture particles from a fluid stream.

Filter elements consistent with the technology disclosed herein can be arranged for “flow-by” filtration, meaning that fluid containing contaminant that flows through the filter from an inlet flow face to an outlet flow face is directed generally parallel to a surface (e.g., top and bottom surfaces) of one or more layers of filter media so that the material flows “by” the surface of the filter media rather than through it. Such an arrangement is generally perpendicular to traditional filter arrangements in which fluid flows directly through the pore structure of the filter material (i.e., through the thickness of the filter material, such as from a top planar surface to a bottom planar surface).

### Chemical Filter Materials

The filter materials consistent with the technology disclosed herein generally include chemical filter materials. In various implementations, the filter material is configured as a sheet, meaning that that the materials are relatively thin and have two opposing primary surfaces. The thickness of the sheet extends from the one primary surface to the opposite primary surface. The sheets of filter materials can each have a thickness of at least 0.15 mm and generally have a thickness of no more than 10 mm. The sheets are generally configured in a filter element for flow-by filtration. Such configurations will be described in more detail below.

The sheet of chemical filter material can be configured as sheet of a mesh or screen having relatively small intersecting fibers or strands. The screen can be constructed of an adsorbent material or a non-adsorbent substrate. In some other embodiments, the sheet of chemical filter material can be configured as a mat, where an adsorbent material or a non-adsorbent substrate is compressed with a binder material to form a relatively homogenous sheet of filter material.

The sheet of chemical of filter material may define interparticle pores that are void spaces defined by the intersecting fibers (when the filter material is configured as a screen) and/or defined between the particles within the sheet (when the filter material is configured as a screen and when the filter material is configured as a mat). The interparticle pore sizes can be designed or selected with consideration of the size of the contaminants to be captured by the particular layers and/or with consideration of the resistance to fluid flow across the filter material evidenced by parameters such as pressure drop. The interparticle pores defined by the sheet of filter material can be constructed to allow for fluid flow while the filter material area surrounding the interparticle pores is configured to capture and retain contaminants.

The sheet of chemical filter material also may have intraparticle pores. The intraparticle pores can include one or more of micropores, mesopores, and macropores. The intraparticle pores may accommodate contaminant capture, chemisorbent impregnation, and/or diffusion. In certain embodiments, the sizes of the macropores of a sheet of chemical filter material are in the range of 50 nm-200 microns measured in the flow through orientation but can more specifically be in the range of 50 nm -100 microns, more specifically 1-50 microns, more specifically 50 nm-25 microns, more specifically 50 nm -15 microns, or even more specifically 50 nm -10 microns. In various embodiments a sheet of chemical filter material includes an adsorbent material such as activated carbon, silica gel, or a molecular sieve. In various embodiments, the chemical filter material is a microporous adsorbent material. In some embodiments, the chemical filter material does not define pores.

Sheets of adsorbent can be coated, reacted, impregnated or washed with particular chemical constituents to modify the chemical filtration performance of the adsorbent. In some embodiments an adsorbent sheet is impregnated with a salt.

In some embodiments the chemical filter material is a non-adsorbent substrate such as a cellulose web that is coated with chemisorbent. The chemical filter material can be a non-adsorbent substrate that is coated with an acid or a base impregnate. The non-adsorbent substrate can be dip-coated, in some implementations.

The chemical filter material can be configured to have relatively high selectivity, adsorption capacity and retention for a particular chemical constituent. Such chemical constituents can include, for example, acid gases such as nitrogen oxide, sulfur dioxide, and hydrogen sulfide, siloxanes, ammonia, n-butane, volatile organic compounds, aromatic hydrocarbons (e.g., benzene, toluene, or xylene).

### Acid Gas Filter Material

In some embodiments, a chemical filter material is configured to remove acid gases from a fluid stream. In some embodiments, the sheet of chemical filter material has an adsorbent or non-adsorbent substrate impregnated with a base, such as potassium carbonate (K₂CO₃). Other bases such as sodium carbonate (Na2CO₃), sodium bicarbonate (NaHCO₃), potassium hydroxide (KOH), potassium iodide (KI) or sodium hydroxide (NaOH) can be used as the impregnate.

In some implementations, the acid gas filter material is configured to partially bond to H₂SO₂/H₂S contaminants in the form of HSOₓ-OH or HS-OH functional groups through the impregnation of relatively weakly basic chemisorbents. Such a configuration may advantageously contribute to the abatement of NH₃ species, as the partially neutralized acids could then act as an additional adsorbent for ammonia. In some embodiments both acidic and basic contaminants can be captured by the acid gas filter material.

In one example, an acid gas filter material is an activated carbon impregnated with potassium carbonate. In another particular example, an acid gas filter material is a granular microporous activated carbon mesh impregnated with 6-7% KI and 3-4% KOH. The carbon mesh size is 12×20. One particular example product is sourced from Haycarb PLC based in Colombo, Sri Lanka. In yet another particular example, the chemical filter material is a mesh granular microporous activated carbon material that is impregnated with 5% potassium iodine and 7.5% sodium hydroxide. The mesh carbon size can be 8×200 although other mesh sizes are also contemplated. One particular example product is Grade RPPE 1034 sourced from Haycarb PLC. Other example impregnates for activated carbon to filter acid gas includes iron oxide and potassium permanganate.

### Ammonia Filter Material

In some embodiments a chemical filter material is configured to remove ammonia from a fluid stream. In some such embodiments the chemical filter material is impregnated or coated with an acid. In some embodiments the chemical filter material is an acid impregnated adsorbent. In some embodiments the chemical filter material is an acid coated non-adsorbent substrate. In various embodiments the acid is citric acid. In some embodiments the acid is not phosphoric acid due to its relatively high vapor pressure.

In one particular example, the chemical filter material is a granular microporous activated carbon mesh material that is impregnated with 22% citric acid. The mesh carbon size can be 8×16 although other mesh sizes are also contemplated. One particular material is sourced from Haycarb PLC based in Colombo, Sri Lanka.

### Test Procedure for Alkane, Siloxane and VOC Adsorption and Retention

Thirteen commercially available carbonaceous adsorbents—some of which contained impregnates—were screened for the static adsorption of toluene, siloxane, pentane, and hexane volatile organic compounds (VOCs) by way of beaker tests. About 0.1 g of adsorbent was placed into a glass vial and heated to 80° C. for 72 hours to degas any pre-adsorbed species. The degassed sample was then sealed into a jar with 5 mL of the desired vapor and allowed to saturate for 24 hours at 25° C., except for siloxane, which had a saturation temperature of 40° C. because siloxane does not have a vapor pressure at ambient conditions. The adsorption capacity was calculated from the initial weight gain of the adsorbent after saturation in the jars.

The cover was then removed from the jar, and the samples were heated to 40° C. Weight losses were recorded at set increments over the course of one week. From this, the sample's retention of the contaminants was calculated. It is noted that, because the jar was open to the environment, the adsorbents had the opportunity to adsorb other environmental species such as water and carbon dioxide and so the calculated retention is an approximation. The chart below provides a brief description of each of the commercially-available adsorbents that were tested:

| | |
|---|---|
| Sample 1 | Unimpregnated activated carbon beads web. |
| Sample 2 | Water washed activated carbon and PTFE |
| | (polytetrafluoroethylene) web, where the activated |
| | carbon is impregnated with potassium carbonate |
| Sample 3 | 8 × 200 mesh granular microporous activated carbon |
| | material that is impregnated with 5% potassium iodine |
| | and 7.5% sodium hydroxide. |
| Sample 4 | Carbon and PTFE mat impregnated with potassium carbonate. |
| Sample 5 | 12 × 20 mesh size granular microporous activated carbon |
| | impregnated with 6-7% KI and 3-4% KOH. |
| Sample 6 | 15% phosphoric acid impregnated 8 × 16 mesh coconut shell |
| | carbon. |
| Sample 7 | Activated carbon bead web impregnated with 1.1% |
| | potassium carbonate (K₂CO₃) by weight. |
| Sample 8 | Unimpregnated activated carbon beads. |
| Sample 9 | 8 × 16 mesh size granular microporous activated carbon |
| | that is impregnated with 22% citric acid. |
| Sample 10 | Unimpregnated water washed activated carbon. |
| Sample 11 | Unimpregnated granular activated carbon. |
| Sample 12 | Granular, unimpregnated carbon mat with a binding agent |
| | laminated to meltblown particulate media on each side. |
| Sample 13 | Granular, unimpregnated carbon mat with a binding agent |
| | laminated to meltblown particulate media on each side. |

Generally a particular filter material was considered desirable for filtering a particular contaminant if it had relatively good adsorption and retention of the target species compared to other target species. A filter material that had high adsorption but low retention of a target species is generally considered undesirable for filtration of that species. Furthermore, a filter material that had high adsorption of a first species may generally considered undesirable if it also has a high adsorption/retention of one or more other species. Additionally, a filter material that had a retention that was higher than 100% was also generally considered undesirable since such data suggests that other species were being adsorbed during the retention phase. Because the testing was conducted under static conditions, the results may be considered a rough approximation of the performance of the material under dynamic, real work conditions. The specific test results are discussed below with reference to each of the types of contaminants tested.

### Alkane Filter Material

In some embodiments a chemical filter material is configured to remove alkanes from a fluid stream. The chemical filter material can be configured to particularly remove butane from the fluid stream. In various embodiments the chemical filter material is configured to capture and retain alkanes such as butane.

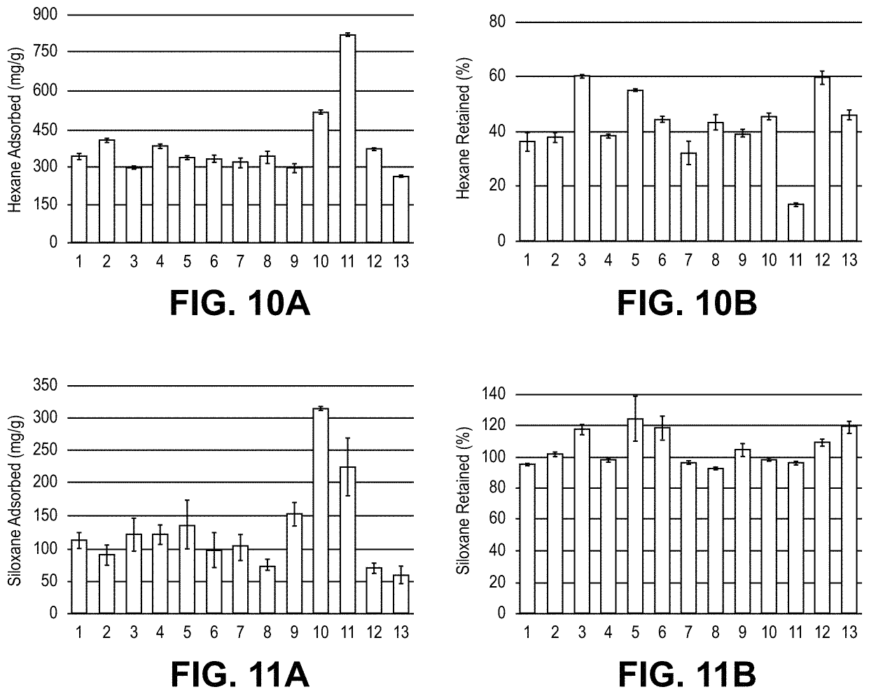

The adsorption/retention results for pentane and hexane according to the test procedure described above are shown in FIGS. 9A-9B and FIGS. 10A-10B, respectively. It should be noted here that the carbons performed similarly regardless of the chain length, meaning that removal performance for pentane may predict butane removal performance, which is a target contaminate in some implementations. Many of the carbon materials adsorbed similar amounts of the alkanes. However, Sample 3, Sample 5, and Sample 12 each appeared to have relatively good alkane retention, meaning that any of these may be effective butane adsorbents. However, Sample 12 had relatively good adsorption of other chemicals as well, and so more analysis is required to predict its adsorption under dynamic conditions where multiple types of chemical contaminants are present. Between Samples 3 and 5, Sample 3 had slightly higher retention, which may be a relatively important performance heuristic. It is noted that Sample 11 had relatively good adsorption of the alkanes but had relatively low retention. This performance of Sample 11 may be desirable performance, however, in some particular implementations.

In some embodiments the chemical filter material is a microporous adsorbent impregnated with one or more bases. The adsorbent can be microporous adsorbent material. The adsorbent can have a variety of ranges of pore sizes, and in one example has a micropore and mesopore pore size distribution of 0.1 nm—50 nm. In one particular example, the chemical filter material is a mesh granular microporous activated carbon material that is impregnated with 5% potassium iodine and 7.5% sodium hydroxide. The mesh carbon size can be 8×200 although other mesh sizes are also contemplated. One particular example product is Grade RPPE 1034 sourced from Haycarb PLC. In another example, the alkane filter material is a granular microporous activated carbon mesh impregnated with 6-7% KI and 3-4% KOH. The carbon mesh size can be 12×20. One particular example product is sourced from Haycarb PLC. In yet another example, the alkane filter material can incorporate a granular activated carbon such as Nuchar RGC sourced from Ingevity headquartered in North Charleston, S.C., USA. Such a granular activated carbon can be configured as a sheet such as a screen or a mat.

### Siloxane Filter Material

In some embodiments a chemical filter material is configured to remove siloxane from a fluid stream. The chemical filter material can generally have a relatively high siloxane capacity and retention. In various embodiments, the chemical filter material is a mesoporous adsorbent.

The siloxane adsorption/retention results according to the test procedure described above are shown in FIGS. 11A-11B. First, it should be noted that nearly every carbon displayed retentions greater than 100% while simultaneously showing relatively low adsorption capacities. This indicates that siloxane was not truly adsorbed, but rather the weight gain was caused by other chemical species (such as water and/or carbon dioxide). The exception, of course, was Sample 10, as this material adsorbed considerably more contaminate than the others and did not have a retention above 100%, potentially indicating that it actually did capture the siloxane target.

In one particular example, the siloxane filter material incorporates a water washed activated carbon, such as product number RGUW 1016 sourced from Haycarb PLC based in Colombo, Sri Lanka. In yet another example, the alkane filter material incorporates a granular activated carbon such as Nuchar RGC sourced from Ingevity headquartered in North Charleston, South Carolina, USA. Such activated carbons can be configured as a sheet such as a screen or a mat.

### VOC Filter Material

In some embodiments a chemical filter material is configured to remove volatile organic compounds (VOCs) from a fluid stream. In some such embodiments the chemical filter material is configured to remove toluene from the fluid stream. The chemical filter material can generally have a relatively high capacity and retention for VOCs. In various embodiments, the chemical filter material has an adsorbent having pore diameters of less than 2 nm. Adsorbents having a relatively small pore size may advantageously retain particularly small chemicals.

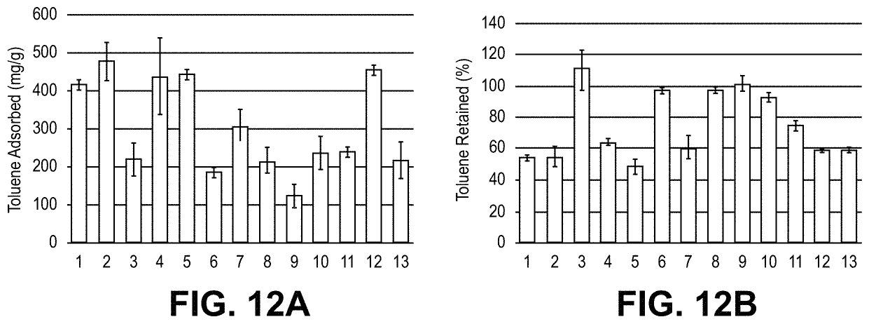

The toluene adsorption/retention results collected in accordance with the test procedure described above are shown in FIGS. 12A and 12B, respectively. Based on the data, there were four carbons which were identified as potential candidates for aromatic VOC filtration: Sample 2, Sample 7, Sample 12, and Sample 13. The particular VOC filtration material chosen may depend on the particular implementation within which the filter material is used, and on the dynamic behavior of the materials in real world conditions. It is noted that the Sample 12 filter material is considered a candidate for a VOC filter material, however, this carbon adsorbed alkanes (described above), as well, so further analysis is required to predict adsorption behavior under dynamic conditions.

In one particular example, the VOC filter material is a carbon air filter media, such as product H&V 5224 V2 sourced from Hollingsworth & Vose based in Hatzfeld, Germany. In yet another example, the VOC filter material is an activated carbon bead web impregnated with 1.1% potassium carbonate (K₂CO₃) by weight. In yet another example, the VOC filter material is a water washed activated carbon and PTFE (polytetrafluoroethylene) web, where the activated carbon is impregnated with potassium carbonate. In yet another example, the VOC filter material is a carbon laminate with meltblown particulate media disposed on each surface of the carbon. The carbon layer is constructed in a mat configuration that is granular carbon with a binding agent.

### Filter Elements

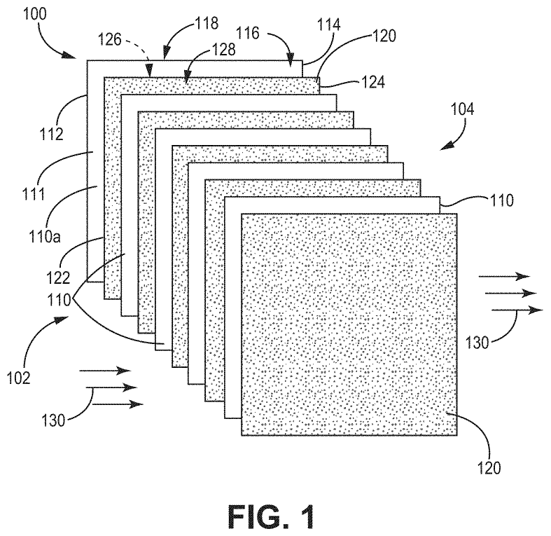

FIG. 1 is an example exploded schematic view of an example chemical filter element consistent with various implementations of the technology disclosed herein. The chemical filter element 100 has a first sheet of a first chemical filter material 110a having a first edge 112 and a second edge 114. The second edge 114 is opposite the first edge 112 relative to the filter element 100. The first sheet 110a has a surface 111. The filter element 100 defines a first filtration flow path 130 from the first edge 112 to the second edge 114. The first filtration flow path 130 is parallel to the surface 111. The first edge 112 is opposite the second edge 114 relative to the surface 111.

In the current example, the filter element 100 has a stack of a plurality of layers of sheets of the chemical filter material 110, which includes the first sheet of material 110a. The plurality of layers of sheets of filter material 110 are stacked such that the surfaces 111 of each sheet are generally parallel to the surfaces 111 of the other layers within the stack. The filtration flow path 130 is defined between the adjacent layers of sheets of filter material 110 in the stack. As such, there are a plurality of filtration flow paths 130.

Similarly to the first sheet of filter material 110a, each of the sheets of the chemical filter material 110 have a first edge 112, a second edge 114, a first surface 116, and a second surface 118. The first surface 116 is opposite the second surface 118. The first edges 112 cooperatively define a first flow face 102 of the filter element 100, and the second edges 114 cooperatively define a second flow face 104 of the filter element 100. The distance between the first flow face 102 and the second flow face 104 is the length of the filtration flow path 130 across the filter element 100. The flow path length can generally be configured to balance the pressure drop across the filter element with the desired exposure time of the contaminated fluid to the filter material in the filter element. As such, the flow path length is not particularly limited. In some embodiments the flow path length is at least 2 cm or 4 cm. The flow path length can generally be less than 160 cm. In some embodiments the flow path length is less than 20 cm. In some embodiments the flow path length ranges from 5-15 cm, 7-13 cm, or 9-11 cm.

The sheets of chemical filter materials 110 can have a variety of configurations, which will be described in more detail below. Generally, each of the sheets of chemical filter material 110 are identical, meaning that each of the sheets of chemical filter material 110 are constructed of the same combinations of materials in the same configuration. However, in some embodiments, each of the sheets of chemical filter material 110 are identical filter materials but may have different sheet sizes or different physical configurations.

In the current example, a flow channel layer 120 abuts the first sheet of the chemical filter material 110. The flow channel layer 120 particularly defines the filtration flow path 130 between the sheets of filter material 110. The flow channel layer 120 has a structure configured to guide fluid flow through the filter element 100 primarily along a surface of one or more sheets of filter material 110. The flow channel layer 120 can extend between the first flow face 102 and the second flow face 104 of the filter element 100. The flow channel layer 120 can have a first edge 122 cooperatively defining the first flow face 102, a second edge 124 cooperatively defining the second flow face 104, a first surface 126 and a second surface 128. The filtration flow path 130 extends from the first edge 122 to the second edge 124. The filtration flow path 130 is adjacent to the first surface 116 of the first sheet of filter material 110a. The filtration flow path 130 is generally planar. The filtration flow path 130 has a thickness extending from the first surface 126 to the second surface 128.

The current example filter element has a plurality of flow channel layers 120. The sheets of the chemical filter material 110 and the flow channel layers 120 are in a stacked, alternating relationship, such that a flow channel layer 120 is disposed between and abuts layers of sheets of filter material 110 in the stack.

In some embodiments the flow channel layer 120 is configured to encourage mixing of the fluid flowing through the filter element 100. In some embodiments the flow channel layer 120 is configured to minimize pressure drop. In some embodiments the flow channel layer 120 is constructed of a chemical filter material such as an adsorbent material.

The flow channel layers 120 can be configured as a mesh or screen type of structure having relatively large intersecting fibers or strands, as compared to the sheet of filter material. In some embodiments the flow channel layers 120 each have relatively large fibers and corresponding large pores of the flow channel layers contribute to the permeability of the filter element. In some embodiments the flow channel layers 120 can be constructed of a sponge or foam material that defines relatively large pores that cumulatively define the filtration flow path 130. Although the flow-by filters disclosed herein are configured so that fluid flows generally across the surfaces of the multiple layers, the size of the pores or openings are measured in the flow-through direction, which is perpendicular to the surfaces of the sheet of filter media. That is, the pore size is measured and selected to provide desired flow characteristics for a flow-by configuration, even though the filter is not arranged for material to flow through the thickness of the filter material.

A common technique used for measuring the pore sizes of either or both of the flow channel layer and the first sheet of a first chemical filter material is capillary flow porometry. This technique uses capillary theory to calculate pore sizes based on the relationship of the surface tension of a liquid, pressure, and diameter of each pore. This measurement method uses a non-reacting liquid to completely wet and fill the pores of the porous material with a fluid that has a very low contact angle to the material. The saturated material is then pressurized with a non-reacting gas while measuring the pressure and air flow until all of the liquid has been forced out of the pores. With this technique, smaller pore sizes will require higher pressure to force the liquid out of the pores, with the opposite result for larger pore sizes. The collected data is then compared to pressure and flow measurements of a clean, dry sample to calculate the pore size distribution. In this measurement, the mean flow pore size is defined at the point for which the wetted sample airflow is equal to half of the dry sample airflow.

In general for various embodiments, the mean flow pore size of the flow channel layer, when measured in the flow through orientation using the above-described techniques and/or other techniques, is greater than the mean flow pore size of the sheet of a chemical filter material (also measured in the flow-through direction). In some embodiments, the chemical filter material does not define pores.

The thickness, spacing, and arrangement of the fibers or strands, along with the overall thickness of the flow channel layer, can be varied to achieve desired filtration performance. In one exemplary embodiment, the overall thickness of the flow channel layer is in the range of approximately 200 μm-5000 μm, more specifically in the range of 200 μm-2000 μm, and more specifically in the range of 500 μm-1000 μm, although the thickness can be smaller or larger than these thickness ranges.

Returning to FIG. 1, the first flow face 102 is opposite the second flow face 104 relative to the filter element 100. In various embodiments, the first flow face 102 is parallel to the second flow face 104. Each of the sheets the filter material 110 and the flow channel layers 120 can be planar. While the surfaces of first sheet of the filter material 110a and the flow channel layer 120 are each substantially flat in the current embodiment, alternatives are possible, which are described in more detail herein.

In some embodiments, the edges of the flow channel layers 120 and the edges of the sheets of filter material 110 are generally aligned with each other in the stack. In certain embodiments, the stack will generally fill the housing, or other structure in which the stack is positioned, in order to maximize the amount of material available for filtration in a given volume. However, in some embodiments the stack of sheets of filter material 110 and flow channel layers 120 can include layers of different sizes and/or shapes so that the edges of the various layers can be staggered in an ordered or random arrangement along the stack. In any of the arrangements where the edges of the layers are not aligned along a plane, the flow face is the non-planar region cumulatively defined by the edges of the layers facing the direction in which material flow is entering or exiting the filter element 100.

Furthermore, while the first edge 112 and second edge 114 of each of the layers of filter material 110 are parallel in the current example, in some other implementations that first edge 112 is non-parallel to the second edge 114. Furthermore, in some embodiments the first edge 112 and/or second edge 114 of a first sheet of filter material 110a is non-parallel to the first edge 112 and/or second edge 114 of another sheet of filter material in the stack. Additionally, while the edges of the filter material are depicted as forming straight lines, in some embodiments one or more of the edges can form a curve or line segments having intersection points.

When in use, the stack of alternating sheets of filter material and flow channel layers can be positioned within a housing or other structure that compresses the layers by a desired amount and/or maintains the stack of layers at a certain compression level once they are positioned within the housing. In one exemplary embodiment, the surface area of the chemical filter material of the flow face of a compressed stack of materials defines approximately 40-80% of the total area of the flow face.

The number of layers in the stack forming the filter element can vary widely but can be in the range of 5-30 layers per inch, or more specifically can be in the range of 10-20 layers per inch, or can even more specifically be 15-25 layers per inch. It is understood, however, that more or fewer layers can be incorporated in a particular filter element. The number of layers can depend on factors such as the volume of fluid flow that the filter element is configured to accommodate and the amount of a particular contaminant the filter element is configured to remove from the fluid flow. In some implementations, the filter element 100 is configured to accommodate fluid flow ranging from 0.5 m³/min—23 m³/min. In some embodiments the filter element 100 is configured to accommodate fluid flow ranging from 3-6 m³/min, 5-11 m³/min, or 6-13 m³/min. In some embodiments the filter element 100 is configured to accommodate fluid flow ranging from 6-13 m³/min. However, the filter element can be constructed to accommodate much larger and much smaller fluid flow rates, depending on the specific operational environment of the filter element.

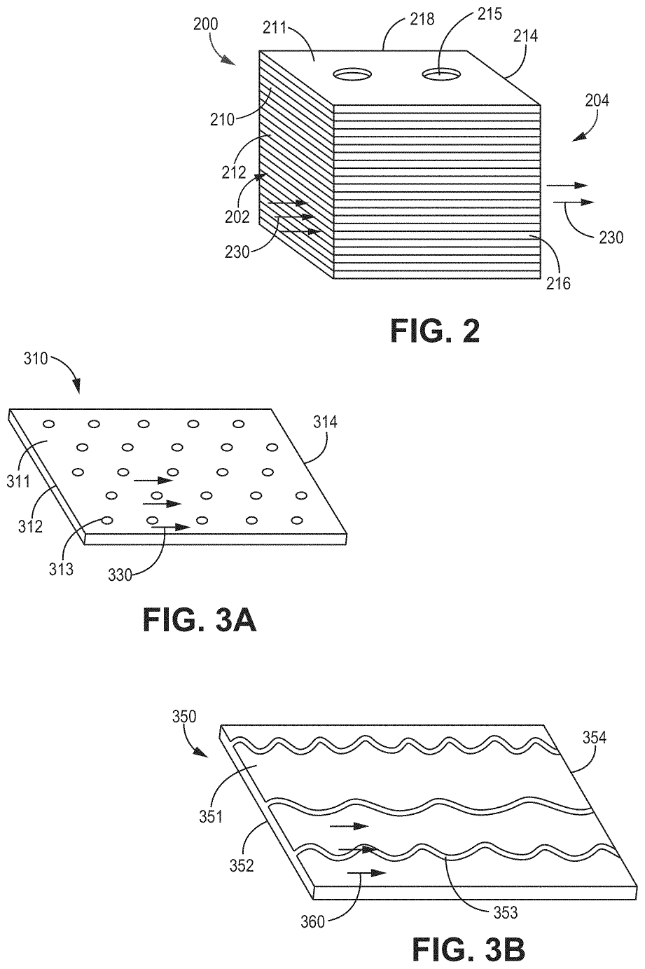

FIG. 2 depicts a schematic example filter element 200 consistent with some embodiments. The discussions of filter elements elsewhere herein generally apply to the current discussion unless contradictory to the current design. The example filter element 200 has a first flow face 202 and a second flow face 204. The example filter element 200 defines a filtration flow path 230 from the first flow face 202 to the second flow face 204. The filter element 200 is constructed of a plurality of layers of filter material 210 in a stacked configuration. Each of the layers of filter material 210 have a surface 211. The filtration flow path 230 extends generally parallel to the surface(s). The first flow face 202 can be defined by a first edge 212 of each of a plurality of layers of sheets of chemical filter material 210. The second flow face 204 can be defined by a second edge 214 of each of the plurality of layers of sheets of chemical filter material 210. As such, the filtration flow path 230 extends from the first edge 212 to the second edge 214 of each of the sheets of filter material 210.

The filter element 200 of FIG. 2 can be consistent with the filter element depicted in FIG. 1, where flow channel layers are alternated with the sheets of filter material within the stack. In some other embodiments, the filter element 200 omits flow channel layers such that each of the layers in the stack are sheets of filter material. In such an example, each of the sheets of filter material 210 abuts at least one adjacent sheet of filter material 210.

In some embodiments, each of the sheets of filter material 210 are individual, discrete sheets. However, in some other embodiments, the sheets of filter material 210 can be defined by a single elongate sheet of filter material 210 that is pleated to define each individual sheet of filter material 210. For example, each sheet of filter material 210 can be coupled to one or more adjacent sheets along a third edge 216 and a fourth edge 218 opposite the third edge 216, where the third edge 216 and the fourth edge 218 define a fold line between the adjacent sheets.

While the current example filter element 200 forms a cube or cuboid, it will be appreciated that filter elements consistent with the technology disclosed herein can have various other shapes. In some embodiments the filter element can define a cylindrical shape, for example. In some embodiments the filter element can define a non-geometric shape. Further, as discussed with reference to FIG. 1, the edges of the sheets of filter material are not necessarily aligned and are not necessarily parallel, and so the corresponding flow faces 202, 204 of the filter element 200 defined by the edges are not necessarily planar and, if they are planar, the flow faces 202, 204 are not necessarily parallel to each other.

In some embodiments, one or more layers of filter material 210 can have one or more holes 215 extending entirely through the sheet of filter material 210 (i.e., from the first surface to the second surface). The one or more holes 215 are generally a discontinuity across and through the surfaces of the filter material 210, as contrasted with interparticle pores, for example, which form the structure of the sheet of filter material 210. The holes 215 can be formed in the sheet of filter material after formation of the sheet of filter material. In some embodiments, the holes 215 have a maximum cross-dimension (such as a diameter or a diagonal measurement) of 50 μm to 5000 μm. The holes 215 can have equal cross-dimensions or can have varying cross-dimensions. The holes 215 can have the same shape, or they can be different shapes. The holes 215 can be uniform across the surface of the sheet of filter material 210 or can be randomly disposed across the sheet of filter material 210. In some embodiments the holes 215 can form a pattern across the sheet of filter material 210 and/or can form a gradient where the density of holes across the sheet of filter material 210 changes across the sheet of filter material 210.

In some embodiments the holes 215 in one layer of filter material are not aligned with the holes 215 in adjacent layers of filter material. The holes 215 generally allow fluid to flow from a first filtration flow path defined between a first pair of adjacent sheets of filter material to a second filtration flow path defined between a second pair of adjacent sheets of filter material within the filter element 200. The one or more holes may advantageously decrease the pressure drop from the first flow face 202 to the second flow face 204 of the filter element 200. It is noted that the incorporating such holes 215 does not significantly change the general flow path of the fluid through the filter element 200 and, as such, the filtration flow paths 230 are recognized as being generally planar.

In various embodiments where each of the layers forming the filter element 200 are sheets of filter material 210, each of the sheets of filter material can be substantially flat. In some other embodiments, the sheets of filter material can define a spacer structure on one or more surfaces that is configured to create a flow channel with an abutting sheet of filter material 210. In some embodiments the spacer structure includes embossments extending between the first edge and the second edge.

FIGS. 3A and 3B depict schematic example sheets of filter material 310, 350 having embossments. Such sheets of filter material 310, 350 can be layered with other sheets of filter material for use in filter elements discussed above or used in other filter element configurations disclosed herein such as coiled arrangements discussed in more detail below.

The sheet of filter material of FIG. 3A has a first surface 311, a first edge 312 and a second edge 314, where the second edge 314 is opposite the first edge 312. The sheet of filter material 310 is configured to define a filtration flow path from the first edge 312 to the second edge 314, in a direction parallel to the first surface 311. The first surface 311 has embossments 313 extending between the first edge 312 and the second edge 314. In the current example the embossments 313 are discrete bulges extending outward from the first surface 311. The embossments 313 help define the filtration flow path 330 across the first surface 311 from the first edge 312 to the second edge 314. The filtration flow path 330 is generally defined around the embossments 313. When the sheet of filter material 310 is stacked with an abutting sheet of filter material, the filtration flow path 330 is defined in the space between the abutting sheet of filter material, the first surface 311, and the embossments 313. The abutting sheet of filter material can also define embossments on one or more surfaces.

In some embodiments, the second surface of the filter material 310 (opposite the first surface 311) also defines embossments. The embossments can be differently configured compared to the embossments on the first surface 311 or they can be the same configuration. While the current example embossments are depicted as discrete nodules, in some other embodiments the embossments can be a plurality of discrete elongate bulges. Further, while in the current example the embossments are protrusions, in some other embodiments one or more embossments can be indentations, an example of which is depicted and discussed with reference to FIG. 3B.

The sheet of filter material of FIG. 3B has a first surface 351, a first edge 352 and a second edge 354, where the second edge 354 is opposite the first edge 352. The sheet of filter material 350 is configured to define a filtration flow path from the first edge 352 to the second edge 354, in a direction parallel to the first surface 351. The first surface 351 has embossments 353 extending between the first edge 352 and the second edge 354. In particular to this embodiment, one or more of the embossments 353 extend from the first edge 352 to the second edge 354. In the current example the embossments 353 are discrete channels in the first surface 351. The embossments 353 help define the filtration flow path 360 across the first surface 351 from the first edge 352 to the second edge 354. The filtration flow path 360 is generally defined by the embossments 353. When the sheet of filter material 350 is stacked with an abutting sheet of filter material, the filtration flow path 360 is defined in the space between the abutting sheet of filter material, the first surface 351, and the embossments 353.

In the current example the embossments 353 extend from the first edge 352 to the second edge 354, but in some other embodiments one or more of the embossments 353 can extend an intermediate distance between the first edge 352 and the second edge 354. The embossments 353 here are undulating, but in some other embodiments the embossments are straight. Undulating embossments 353 may advantageously cause mixing of flowing fluid to maximize interaction between chemical constituents in the flowing fluid and the filter material 350. While in the current example the embossments 353 extend in a direction generally parallel to the filtration flow path 360, in some other embodiments the embossments can extend in a direction generally perpendicular to the filtration flow path. As mentioned above, instead of being formed as indentations in the surface of the filter material 350, the embossments can be formed as protrusions extending out from the surface of the filter material 350.

Similar to the discussion of FIG. 3A, the second surface opposite the first surface 351 can have embossments, or the second surface can lack embossments and can be substantially flat.

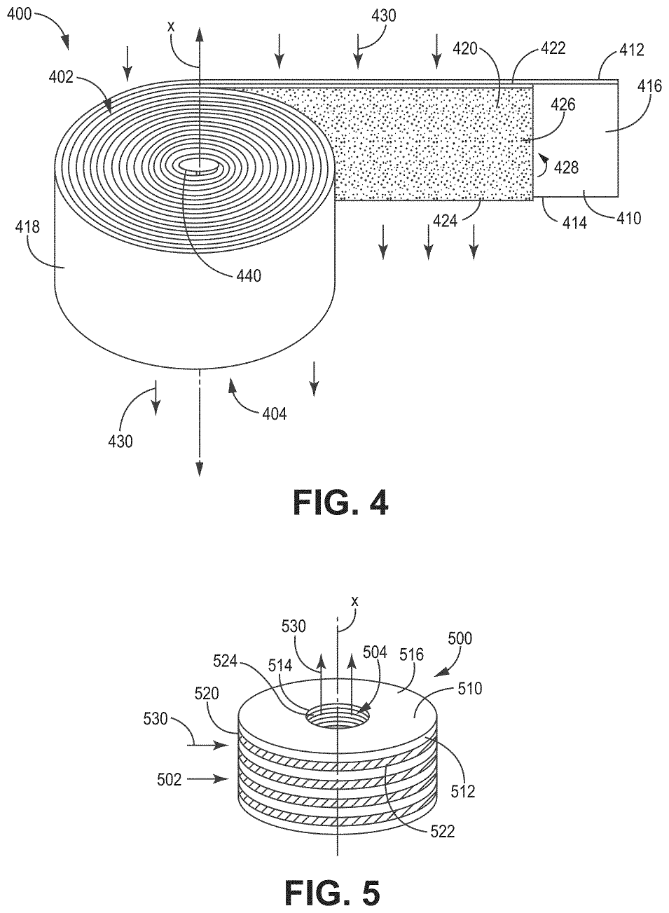

FIG. 4 depicts another example flow-by filter element consistent with some examples. The discussions of filter elements elsewhere herein generally apply to the current discussion unless contradictory to the current design. The example schematic filter element 400 of FIG. 4 has a sheet of a chemical filter material 410 having a first surface 416, a second, opposite surface 418, a first edge 412 and a second, opposite edge 414. A filtration flow path 430 is defined parallel to the first surface 416. The filtration flow path 430 extends from the first edge 412 to the second edge 414.

Unlike the embodiments depicted in FIGS. 1 and 2, in the current example, the filter element 400 is constructed of a sheet of filter material 410 that is in a coiled configuration about a central axis x. The sheet of filter material 410 is elongate. The first edge 412 of the sheet of filter material 410 defines a first flow face 402 and the second edge 414 defines a second flow face 404. Each of the first edge 412 and the second edge 414 are elongate edges of the sheet of filter material 410.

While the current example depicts filter media in a generally cylindrical configuration having a generally circular cross section, it will be appreciated that other coiled configurations are possible. In some embodiments the cross-section of the coiled media through the central axis x can be ovular or polygonal.

In the current example, a flow channel layer 420 abuts the sheet of filter material 410, wherein the flow channel layer 420 has a first edge 422 cooperatively defining the first flow face 402, a second edge 424 cooperatively defining the second flow face 404, a first surface 426 and an opposite second surface 428 (not directly visible). The flow channel layer 420 can be consistent with flow channel layers described elsewhere herein except where specified in the current discussion and/or figure. The flow channel layer 420 defines a filtration flow path 430 from the first flow face 402 to the second flow face 404. The filtration flow path 430 extends in the axial direction, that is, from the first edge 422 to the second edge 424 of the flow channel layer 420. The filtration flow path 430 abuts the first surface 416 of the sheet of filter material 410.

In the current example, the flow channel layer 420 is an elongate sheet. The flow channel layer 420 is arranged in a coiled configuration about the central axis x. The flow channel layer 420 is in contact with the adjacent sheet of filter material 410, and the pair of layers 410, 420 is rolled or coiled either about itself or around a core 440 that extends along the longitudinal axis x to create the filter element 400. In this configuration, fluid can flow from the top (relative to the figure) of the coiled layers (i.e., one end of the filter element 400) to the bottom of the coiled layers (i.e., the opposite end of the filter element 400) across the rolled surface of the first sheet of filter material 410 along the flow channel layer 420. Alternatively, fluid can flow in the opposite direction (i.e., from the bottom of the roll to the top of the roll relative to the figure). The first flow face 402 is opposite the second flow face 404 relative to the filter element 400. In the current example, the first flow face 402 is parallel to the second flow face 404. While the first sheet of the filter material 410 and the flow channel layer 420 are each substantially flat in the current embodiment, in some examples, one or both of the layers define a plurality of embossments, as described above with reference to FIGS. 3A and 3B.

It is noted that, unlike previously disclosed embodiments, here the sheet of filter material 410 does not generally extend in a plane. Rather, the sheet of filter material 410 is coiled and thus each of the surfaces 416, 418 are also coiled. However, the filtration flow path 430 extends generally linearly from one flow face to the other flow face in the axial direction.

It will be noted that in various implementations, such as in an embodiment alternate to FIG. 4, the flow channel layer is omitted. In some such examples the sheet of filter material can define embossments extending between the first edge 412 and the second edge 414 as discussed above. Furthermore, as discussed above with reference to FIG. 2, in some embodiments the sheet of filter material can have one or more holes extending through the sheet of filter material 410.

FIG. 5 depicts yet another example filter element consistent with some embodiments. The discussions of filter elements elsewhere herein generally apply to the current discussion, unless contradictory to the current design. The example schematic filter element 500 of FIG. 5 has a first sheet of a filter material 510 having a first edge 512 defining a first flow face 502, a second edge 514 defining a second flow face 504, a first surface 516 and a second surface (not visible) opposite the first surface. A flow channel layer 520 is abutting the first sheet of filter material 510. The flow channel layer 520 has a first edge 522 cooperatively defining the first flow face 502, a second edge 524 cooperatively defining the second flow face 504, a first surface and a second surface (not visible) opposite the first surface. The flow channel layer 520 defines a filtration flow path 530 from the first flow face 502 to the second flow face 504 of the filter element 500. The filtration flow path 530 extends from the first edge 522 to the second edge 524. The filtration flow path 530 is parallel to and abutting at least one surface of the filter material 510. A plurality of filtration flow paths 530 can be defined between adjacent layers of filter material 510 in the stack.

In the current example, the sheets of the filter material 510 and the flow channel layers 520 are alternating disks that are in a stacked configuration. Each flow channel layer 520 abuts at least one adjacent first sheet of filter material 510. Each of the disks of the first sheet of filter material 510 and the flow channel layer 520 are stacked along a longitudinal axis x to form the filter element 500. Each of the disks define an opening, and the openings generally overlap to define a portion of the filtration flow path. the stack of disks cumulatively define an outer perimetric surface that is the first flow face 502 and an inner perimetric surface that is a second flow face 504. While in the current example the outer perimetric surface and the inner perimetric surface are depicted as cylindrical, other shapes are certainly contemplated.

The filtration flow path 530 across each of the layers of filter media 510 is generally linear. In examples consistent with the current embodiment, fluid is configured to flow radially from one flow face to the other flow face. For example, fluid is configured to flow either from first flow face 502 of the element toward the opening (second flow face 504) of the filter element 500 or from the opening (second flow face 504) toward the first flow face 502 in a flow-by type of flow path. That is, fluid flow through the filter element 500 will be generally perpendicular to the longitudinal axis x. Unlike some previous examples discussed, in the current example, the first flow face 502 is not opposite the second flow face 504. In the current example, the first flow face 502 surrounds the second flow face 504. More particularly, in this example, the first flow face 502 is concentric to the second flow face 504, meaning that the first flow face 502 and the second flow face 504 share a central axis x.

In various embodiments the flow channel layers 520 can be omitted. In some such embodiments one or both surfaces of each sheet of filter material 510 can have one or more embossments, as has been described above. In other such embodiments, each sheet of filter material 510 can lack embossments.

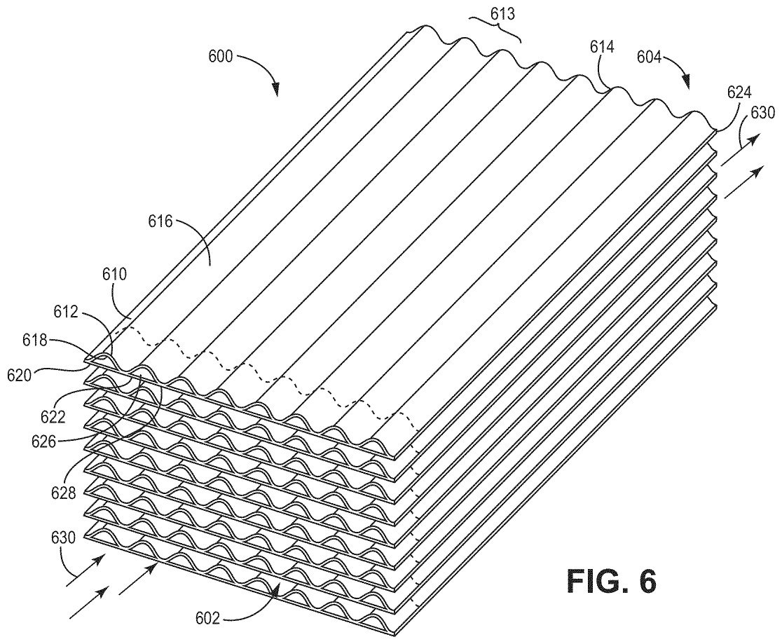

FIG. 6 depicts yet another example filter element having a flow-by configuration consistent with the technology disclosed herein. The discussions of filter elements elsewhere herein generally apply to the current discussion, unless contradictory to the current design. The materials of the layers can generally be consistent with discussions below. The example schematic filter element 600 has a first layer of a sheet of filter material 610 having a first edge 612 defining a first flow face 602, a second edge 614 defining a second flow face 604, a first surface 616 and a second surface 618 (not directly visible) opposite the first surface. A second layer of a sheet of filter material 620 is adjacent to the first sheet of filter material 610. The second sheet 620 has a first edge 622 cooperatively defining the first flow face 602, a second edge 624 (partially visible) cooperatively defining the second flow face 604, a first surface 626 and a second surface 628 (not directly visible). The second sheet of filter material 620 defines a filtration flow path 630 from the first flow face 602 to the second flow face 604. The filtration flow path 630 extends from the first edges 612, 622 to the second edges 614, 624. The filtration flow path 630 is generally parallel to the surfaces of the sheets of filter material 610, 620.

The first layers of filter material 610 and the second layers of filter material 620 are in a stacked, alternating relationship, such that a second layer of filter material 620 is positioned between two first layers of filter material 610. A plurality of filtration flow paths 630 are defined between adjacent layers of filter material 610, 620 in the stack. In the current embodiment, the first layers of filter material 610 are in a fluted configuration, meaning that the first layer of filter material 610 defines flutes 613 extending from the first flow face 602 to the second flow face 604. The flutes 613 are a type of spacer structure alternate to embossments, which were discussed above. The flutes 613 particularly define the filtration flow path 630 between the first flow face 602 and the second flow face 604. The first layers of filter material 610 are generally sheets of filter material. The second layers of filter material 620 can be the same type of sheets of filter material as those of the first layers of filter material 610, albeit with a different structural configuration. In the current example, each of the second layers of filter material 620 are substantially planar.

The first flow face 602 is opposite the second flow face 604 relative to the filter element 600. The first flow face 602 is parallel to the second flow face 604 in this example, but in some other embodiments the flow faces 602, 604 are not parallel. Similar to embodiments discussed above, the edges of the first layers of filter material 610 and the second layers of filter material 620 are generally aligned with each other in the stack.

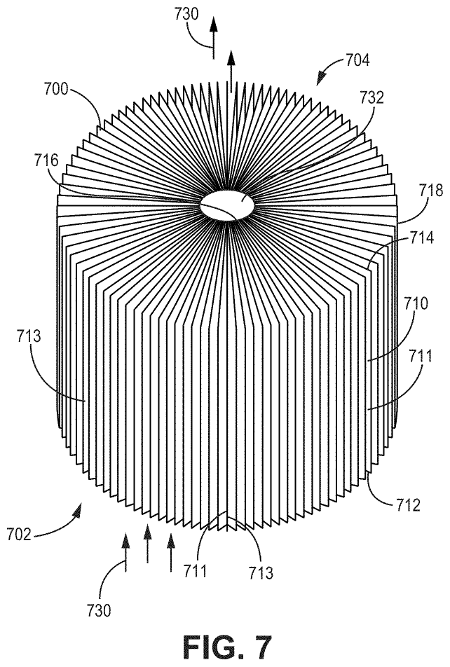

FIG. 7 is yet another example schematic of an example chemical filter element 700 consistent with various implementations of the technology disclosed herein. The chemical filter element 700 has a first sheet of a first chemical filter material 710 having a first edge 712 and a second edge 714. The second edge 714 is opposite the first edge 712 relative to the filter element 700. The first sheet 710 has a first surface 711 and a second surface 713. The filter element 700 defines a first filtration flow path 730 from the first edge 712 to the second edge 714. The first filtration flow path 730 is parallel to the surface 711.

In the current example, the filter element 700 has plurality of layers of sheets of the chemical filter material 710 (which includes the first sheet of filter material 710), that each extend radially outward from a filter core 732. The filter core 732 can be a plug that helps define the filtration flow path 730 across the plurality of sheets of filter material. The filter core 732 can be configured to prevent fluid flow from bypassing the filter material 710. Each of the plurality of layers of sheets 710 has a third edge 716 that is coupled to the filter core 732 and a fourth edge 718 that is positioned radially outward from the third edge 716 and the filter core 732. In the current example, the surfaces 711, 713 of each of the sheets are non-parallel to the surfaces 711, 713 of a plurality of other layers within filter element 700. The first filtration flow path 730 is defined between the adjacent layers of sheets 710 in the filter element 700.

Similarly to the first sheet of filter material 710, each of the sheets of the chemical filter material 710 have a first edge 712, a second edge 714, a first surface 711, and a second surface 713. The first surface 711 is opposite the second surface 713. The first edges 712 cooperatively define a first flow face 702 of the filter element 700, and the second edges 714 cooperatively define a second flow face 704 of the filter element 700. As such, the first flow face 702 is opposite the second flow face 704 relative to the filter element 700. In various embodiments, the first flow face 702 is parallel to the second flow face 704, but other configurations are also contemplated where the first flow face 702 is non-parallel to the second flow face 704. Each of the sheets of the filter material 710 (and the flow channel layers, if included) can be planar, as depicted. The distance between the first flow face 702 and the second flow face 704 is the length of the filtration flow path 730 across the filter element 700.

While the first edge 712 and second edge 714 of each of the layers of filter material 710 are parallel in the current example, in some other implementations the first edge 712 is non-parallel to the second edge 714. Furthermore, in some embodiments the first edge 712 and/or second edge 714 of a first sheet of filter material 710 is non-parallel to the first edge 712 and/or second edge 714 of another sheet of filter material in the filter element 700. Additionally, while the edges of the sheets of filter material 710 are depicted as forming straight lines, in some embodiments one or more of the edges can form a curve or line segments having intersection points. In the current example, each of the sheets of filter material 710 are generally planar, but in some other embodiments, each of the sheets of filter material 710 can define discontinuities such as holes or embossments.

The sheets of chemical filter materials 710 can have a variety of configurations, as discussed elsewhere herein. Generally, each of the sheets of chemical filter material 710 are identical, meaning that each of the sheets of chemical filter material 710 are constructed of the same combinations of materials in the same configuration. However, in some embodiments, each of the sheets of chemical filter material 710 are identical filter materials but may have different sheet sizes or alternating configurations. Further, in the current example each of the plurality of sheets of filter material are discrete, separate sheets. However, in some other embodiments the plurality of sheets of filter material are formed from a continuous sheet of chemical filter material that is pleated. In such a configuration, the third edge 716 and the fourth edge 718 of each of the plurality of sheets of filter material 710 can be a fold line separating one sheet of filter material from an adjacent sheet of filter material.

In the current example, a flow channel layer is omitted, but in some other embodiments a plurality of flow channel layers can be disposed between adjacent sheets of filter material 710. The flow channel layer, if included, can be consistent with flow channel layers discussed above, but in the current implementation would be coupled to the filter core 732 at one edge and would extend radially outward from the filter core 732.

The fourth edges 718 of each of the plurality of sheets of filter material forms an outer perimetric boundary of the filter element 700. In various embodiments, the filter element 700 is configured to be received by a housing that obstructs fluid flow around the outer boundary of the filter element 700 to direct fluid flow across the sheets of filter material 710 from the first edge 712 to the second edge 714. In some embodiments the housing is sized to displace the fourth edges 718 of each of the plurality of sheets of filter material such that, upon insertion into the housing, each of the plurality of sheets of filter material bend to form a curved surface between the third edge 716 and the fourth edge 718.

### Filtration Assemblies

Filtration assemblies consistent with the technology disclosed herein can incorporate multiple chemical filter elements, such as those described above. The filter elements are generally arranged in a series along a filtration flow path. Each chemical filter element can be configured to target a particular chemical species within its intended operating environment. In some embodiments, each chemical filter element within the assembly is configured to target a different chemical species than other chemical filter elements within the assembly. In various embodiments, each of the chemical filter elements within the assembly are constructed of a different type of chemical filter material, meaning that each chemical filter element has chemical filter material having a different pore size distribution and/or different chemical treatment than the other chemical filter elements in the assembly.

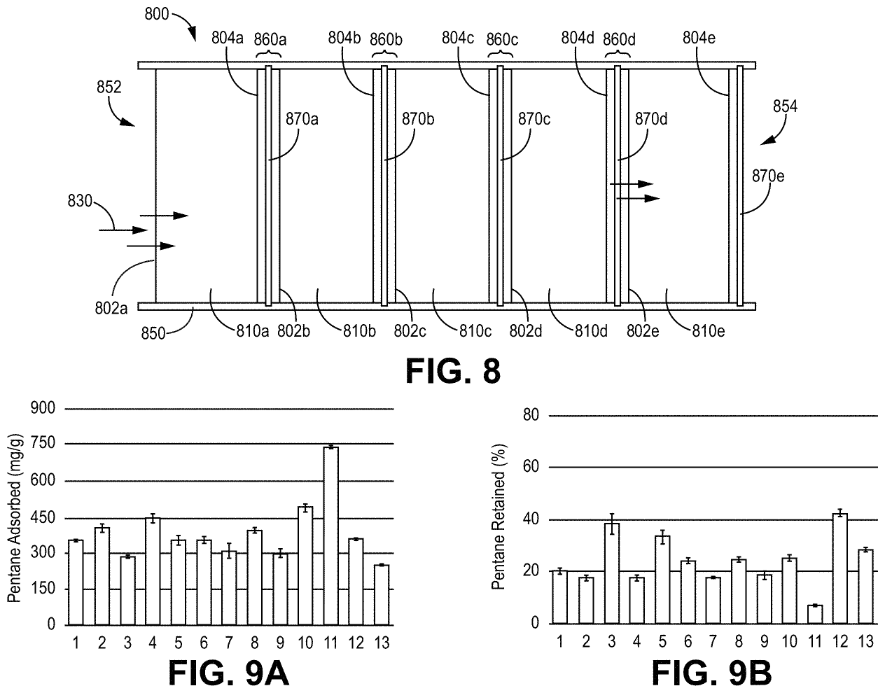

FIG. 8 is an example filter assembly consistent with the technology disclosed herein. The filter assembly 800 has a housing 850. The housing 850 defines an inlet 852 and an outlet 854. A plurality of chemical filter elements 810a-e are disposed within the housing 850. The filter elements 810a-e are arranged in a series with respect to fluid flow from the inlet 852 to the outlet 854. A spacing region 860a-d is between adjacent filter elements 810a-e in the series.

Each of the chemical filter elements 810a-e can be consistent with the chemical filter elements described herein with reference to FIGS. 1-7. As such, each chemical filter element 810a-e can have chemical filter material configured as a sheet having a first edge and a second edge, and each chemical filter element defines a filtration flow path extending parallel to a surface of the sheet and the filtration flow path extends from the first edge to the second edge. While the first edge and the second edge are not necessarily particularly visible in FIG. 8, the first edge defines the first flow face 802a-e of each filter element 810a-e and the second edge defines the second flow face 804a-e of the filter element 810a-e.

While not visible in the current figure, one or more of the plurality of filter elements 810a-e may have a flow channel layer defining the filtration flow path, as discussed above. Such a flow channel layer may abut the surface of the sheet of filter material between the first edge and the second edge as discussed above. Furthermore, one or more of the chemical filter elements 810a-e can be constructed of a stack of a plurality of layers of sheets of chemical filter material, wherein the filtration flow path is defined between adjacent layers in the stack. Such example configurations are discussed above with reference to FIGS. 1, 2, 5 and 6. In some such embodiments, a filter element can have a stack of a plurality of flow channel layers defining the first filtration flow path, wherein each flow channel layer is disposed between and abuts layers of sheets of the first chemical filter material in the stack as discussed above with reference to FIGS. 1, 5 and 6.

One or more of the plurality of filter elements 810a-e may have a sheet of the filter material arranged in a coiled configuration about a central axis, such as described above with reference to FIG. 4. Some such filter elements 810a-e may have a flow channel layer that is also in a coiled configuration about the central axis. Some such filter elements 810a-e may have embossments defined by the sheets that extend between the first edge and the second edge. One or more of the plurality of filter elements 810a-e may have a sheet of filter material that has one or more holes extending entirely through the sheet.

One or more of the plurality of filter elements 810a-e may have a plurality of sheets of filter material that are arranged to extend radially outward from a filter core, such as described above with reference to FIG. 7. Some such filter elements 810a-e may have a flow channel layer. Some such filter elements 810a-e may have embossments defined by the sheets that extend between the first edge and the second edge. One or more of the plurality of filter elements 810a-e may have a sheet of filter material that has one or more holes extending entirely through the sheet.

In various embodiments, the filter assembly is configured to form a seal around the flow faces of each of the filter elements 810a-e to prevent the fluid to-be filtered from bypassing the flow path extending through each filter element. The seal may be a gasket, for example, that is disposed between the filter element and an inner surface of the filter housing 850 at a location adjacent to or abutting each flow face. In some embodiments each of the individual filter elements 810a-e can be housed separately such that each filter element 810a-e has an element housing that is configured to be inserted in the filter assembly housing 850. The element housing can define the flow path through the filter element 810a-e from the first flow face to the second flow face and prevent fluid from bypassing the filter material of the filter element. In such an example, a seal can be defined between the filter element housing and the filter assembly housing 850.

One or more of the plurality of chemical filter elements 810a-e may be an adsorbent filter element. In some embodiments, at least one of the chemical filter elements is a chemisorbent coated substrate.

In some embodiments, one or more of the chemical filter elements has an acid gas filter material, such as a non-adsorbent substrate coated with a base. In one example one or more of the chemical filter elements includes an adsorbent impregnated with a base. In an example implementation, a first chemical filter element 810a has an adsorbent impregnated with a base. In some embodiments the filter element having the acid gas filter material is in the upstream-most position within the filter assembly. Such a configuration may advantageously neutralize and/or remove acid gases from the fluid stream before such gases negatively interact with subsequent filter elements in the assembly that may, for example, hasten decomposition of the subsequent filter elements.

In some embodiments, one or more of the chemical filter elements includes an ammonia filter material such as an acid coated non-adsorbent substrate or an acid impregnated adsorbent. In an example implementation, a second chemical filter element 810b of the plurality of chemical filter elements 810a-e has an acid impregnated adsorbent. The acid impregnated adsorbent can be, for example, citric acid. In the current example, the filter element having the ammonia filter material is positioned downstream of the filter element having the acid gas filter material. While ammonia can contribute to deactivation of various chemical filter materials, in some implementations ammonia is not as corrosive to the filter assembly as acid gases.

Positioning the ammonia filter element downstream of the acid gas filter element may advantageously provide an opportunity for captured ammonia to capture various acidic species (for example, CO₂, SOₓ, NOₓ, and H₂S) that may remain in the fluid stream after exiting the filter element having the acid gas filter material. While not intending to be bound by theory, the ammonia may bond with H⁺ in citric acid to form NH₄⁺, which can then react with the acidic anions to act as a secondary neutralizing agent. As a result, the ammonia filter element may advantageously exhibit acid gas removal over time as the ammonia filter material becomes saturated with ammonia and can act as an additional acid species chemisorbent.

In some embodiments, one or more of the chemical filter elements includes an alkane filter material. The chemical filter element(s) may be particularly adapted to remove butane from the fluid stream. In an example implementation, a third chemical filter element 810c of the plurality of filter elements 810a-e has the alkane filter material. In some embodiments, the third chemical filter element 810c is downstream of the second chemical filter element 810b.

In some embodiments, one or more of the plurality of chemical filter elements 810a-e has a siloxane filter material. In one example implementation, a fourth chemical filter element 810d of the plurality of chemical filter elements 810a-e has a siloxane filter material. In some embodiments the siloxane filter element is downstream of the acid gas filter element, ammonia filter element, and the alkane filter element. In the current example, the fourth filter element 810d is positioned downstream of the third filter element 810c.

In some embodiments, one or more of the plurality of chemical filter elements 810a-e has a VOC filter material. In one example implementation, a fifth chemical filter element 810e of the plurality of chemical filter elements 810a-e has a VOC filter material. In some embodiments the VOC filter element is downstream of the acid gas filter element, ammonia filter element, and the alkane filter element. In some embodiments the VOC filter element is downstream of the siloxane filter element. In some other embodiments the siloxane filter element is downstream of the VOC filter element. In the current example, the fifth chemical filter element 810e is downstream of the fourth chemical filter element 810d.

While in the current example, the filter assembly 800 has five chemical filter elements 810a-e, fewer chemical filter elements or more filter elements can be incorporated in the assembly 800.

A spacing region 860a-d can be defined between adjacent chemical filter elements 810a-e. The spacing region 860a-d defines a flow pathway from an upstream chemical filter element (such as the first chemical filter element 810a) to a downstream chemical filter element (such as the second chemical filter element 810b). The spacing region 860a-d may advantageously reduce pressure drop along the filtration flow path 830 from the housing inlet 852 to the housing outlet 854. The spacing region 860a-d may advantageously encourage gas mixing which may increase exposure of contaminants to the chemical filter material. In some implementations, the spacing region 860a-d may advantageously prevent one or more chemical filter elements 810a-e from reacting with adjacent chemical filter elements 810a-e, such as where a base impregnated adsorbent is arranged adjacent to an acid impregnated or acid washed adsorbent. The spacing region 860a-d may advantageously prevent chemical migration between adjacent chemical filter elements 810a-e. In some embodiments the filter assembly lacks a spacing region between at least two adjacent chemical filter elements 810a-e.

In some embodiments, a particle filter 870a-d is positioned within a spacing region 860a-d. downstream of one or more of the chemical filter elements 810a-e. Each of the particle filters 870a-d may advantageously be configured to capture any particulate shed by the chemical filter elements 810a-e. The particle filters 870a-d are generally have a flow-through configuration, where the fluid flows through the sheet(s) of filter media of the particle filters 870a-d. As such, the flow pathway extends through each of the particle filters 870a-d. In some embodiments the assembly 800 omits particle filters 870a-d disposed in the spacing regions. In some embodiments a particle filter 870e is disposed across the filtration flow path 830 adjacent the housing outlet 854. Such a particle filter 870e may be positioned at the outlet 854 or between the outlet 854 and the last chemical filter element in the series (the fifth chemical filter element 8810e in the current example). In some embodiments a particle filter is disposed in the housing 850 upstream to the upstream-most chemical filter element. (here, the first chemical filter element 810a).

In some embodiments one or more of the particle filter elements incorporate a chemical filtration component, such as adsorbent or chemically reactive fibers. In other embodiments, each of the particle filter elements lacks a chemical filtration component.

The length of the filtration flow path 830 of the filter assembly 800 accommodates at least the sum of the flow path length of each of the plurality of filter elements 810a-e, plus the length of each spacing region 860a-d (if included), plus the distance between the last filter element 804e in the series and a downstream particle filter 870e (if included). The length of the filtration flow path 830 from the inlet 852 to the outlet 854 of the filter assembly 800 is not particularly limited, and can generally be a balance of a desirable pressure drop and filtration efficiency across the assembly at the required fluid flow rates. In various embodiments, the length of the filtration flow path 830 from the inlet 852 to the outlet 854 of the filter assembly 800 is at least 20 cm. In various embodiments the length of the filtration flow path 830 from the inlet 852 to the outlet 854 of the filter assembly 800 is less than 1500 cm, 1000 cm, 500 cm or 100 cm. In some implementations, the length of the filtration flow path 830 from the inlet 852 to the outlet 854 of the filter assembly 800 ranges from 40-60 cm. In one particular example the length of the filtration flow path 830 from the inlet 852 to the outlet 854 of the filter assembly 800 is 50 cm.

### Exemplary Filtration Assemblies

Embodiment 1. A filter assembly comprising:

a housing;

a first chemical filter element comprising a first sheet of a first chemical filter material having a first edge and a second edge, wherein a first filtration flow path is defined parallel to a surface of the first sheet and the first filtration flow path extends from the first edge to the second edge; and

a second chemical filter element comprising a second sheet of a second chemical filter material having a first edge and a second edge, wherein a second filtration flow path is defined parallel to a surface of the second sheet and the second filtration flow path extends from the first edge to the second edge, wherein the first chemical filter element and the second chemical filter element are disposed in the housing and the second chemical filter element is positioned downstream of the first chemical filter element.

Embodiment 2. The filter assembly of any one of embodiments 1 and 3-22, further comprising a spacing region between the first chemical filter element and the second chemical filter element, wherein the spacing region defines a flow pathway from the first chemical filter element to the second chemical filter element.

Embodiment 3. The filter assembly of any one of embodiments 1-2 and 4-22, further comprising a particle filter disposed in the spacing region, wherein the particle filter comprises particle filtration media and the flow pathway extends through the particle filtration media.

Embodiment 4. The filter assembly of any one of embodiments 1-3 and 5-22, wherein the first chemical filter element further comprises a stack of a plurality of layers of sheets of the first chemical filter material including the first sheet, wherein the first filtration flow path is defined between adjacent layers in the stack.

Embodiment 5. The filter assembly of any one of embodiments 1-4 and 6-22, wherein the first chemical filter element further comprising a stack of a plurality of flow channel layers defining the first filtration flow path, wherein each flow channel layer is disposed between and abuts layers of sheets of the first chemical filter material in the stack.

Embodiment 6. The filter assembly of any one of embodiments 1-5 and 7-22, wherein the first sheet of the first chemical filter material is in a coiled configuration about a central axis.

Embodiment 7. The filter assembly of any one of embodiments 1-6 and 8-22, wherein the first chemical filter element further comprises a flow channel layer abutting the first sheet of the first chemical filter material, wherein the flow channel layer defines the first filtration flow path, and the flow channel layer is in a coiled configuration about the central axis.

Embodiment 8. The filter assembly of any one of embodiments 1-7 and 9-22, wherein the first sheet of the first chemical filter material has embossments extending between the first edge and the second edge.

Embodiment 9. The filter assembly of any one of embodiments 1-8 and 10-22, wherein the first sheet of the first chemical filter material has one more holes extending entirely through the first sheet of the first chemical filter material.

Embodiment 10. The filter assembly of any one of embodiments 1-9 and 11-22, a third chemical filter element comprising a third sheet of a third chemical filter material having a first edge and a second edge, wherein a third filtration flow path is defined parallel to a surface of the third sheet and the third filtration flow path extends from the first edge to the second edge.

Embodiment 11. The filter assembly of any one of embodiments 1-10 and 12-22, further comprising a spacing region defining a flow pathway from the second chemical filter element to the third chemical filter element.

Embodiment 12. The filter assembly of any one of embodiments 1-11 and 13-22, wherein the first chemical filter material comprises an adsorbent impregnated with a base.

Embodiment 13. The filter assembly of any one of embodiments 1-12 and 14-22, wherein the first chemical filter material comprises an acid impregnated adsorbent.

Embodiment 14. The filter assembly of any one of embodiments 1-13 and 15-22, wherein the second chemical filter material comprises an acid impregnated adsorbent.

Embodiment 15. The filter assembly of any one of embodiments 1-14 and 16-22, wherein the second chemical filter material comprises an adsorbent impregnated with a base.

Embodiment 16. The filter assembly of any one of embodiments 1-15 and 17-22, wherein the first edge is opposite the second edge of the first sheet of chemical filter material.

Embodiment 17. The filter assembly of any one of embodiments 1-16 and 18-22, a fourth chemical filter element comprising a fourth sheet of a fourth chemical filter material having a first edge and a second edge, wherein a fourth filtration flow path is defined parallel to a surface of the fourth sheet and the fourth filtration flow path extends from the first edge to the second edge.

Embodiment 18. The filter assembly of any one of embodiments 1-17 and 19-22, further comprising a spacing region defining a flow pathway from the third chemical filter element to the fourth chemical filter element.

Embodiment 19. The filter assembly of any one of embodiments 1-18 and 20-22, wherein the fourth chemical filter material comprises a mesoporous absorbent.

Embodiment 20. The filter assembly of any one of embodiments 1-19 and 21-22, further comprising a fifth chemical filter element comprising a fifth sheet of a fifth chemical filter material having a first edge and a second edge, wherein a fifth filtration flow path is defined parallel to a surface of the fifth sheet and the fifth filtration flow path extends from the first edge to the second edge.

Embodiment 21. The filter assembly of any one of embodiments 1-20 and 22, further comprising a spacing region defining a flow pathway from the fourth chemical filter element to the fifth chemical filter element.

Embodiment 22. The filter assembly of any one of embodiments 1-21, wherein the first chemical filter material comprises a chemisorbent coated substrate.

Embodiment 23. A filter assembly comprising:

a housing defining an inlet and an outlet;

a plurality of chemical filter elements within the housing arranged in a series with respect to fluid flow from the inlet to the outlet; and

a spacing region between adjacent filter elements in the series.

Embodiment 24. The filter assembly of any one of embodiments 23 and 25-40, wherein each chemical filter element comprises chemical filter material configured as a sheet having a first edge and a second edge, and each chemical filter element defines a filtration flow path extending parallel to a surface of the sheet and the filtration flow path extends from the first edge to the second edge.

Embodiment 25. The filter assembly of any one of embodiments 23-24 and 26-40, wherein a first chemical filter element of the plurality of chemical filter elements comprises a flow channel layer defining the filtration flow path, wherein the flow channel layer abuts the surface of the sheet between the first edge and the second edge.

Embodiment 26. The filter assembly of any one of embodiments 23-25 and 27-40, wherein a first chemical filter element of the plurality of chemical filter elements comprises a stack of a plurality of layers of sheets of chemical filter material, wherein the filtration flow path is defined between adjacent layers in the stack.

Embodiment 27. The filter assembly of any one of embodiments 23-26 and 28-40, wherein the first chemical filter element of the plurality of chemical filter elements further comprises a stack of a plurality of flow channel layers defining the first filtration flow path, wherein each flow channel layer is disposed between and abuts layers of sheets of the first chemical filter material in the stack.

Embodiment 28. The filter assembly of any one of embodiments 23-27 and 29-40, wherein the sheet of the first chemical filter material is in a coiled configuration about a central axis.

Embodiment 29. The filter assembly of any one of embodiments 23-28 and 30-40, wherein the sheet comprises embossments extending between the first edge and the second edge.

Embodiment 30. The filter assembly of any one of embodiments 23-29 and 31-40, wherein the sheet of the first chemical filter material has one more holes extending entirely through the sheet.

Embodiment 31. The filter assembly of any one of embodiments 23-30 and 32-40, wherein one or more chemical filter elements is an adsorbent filter element.

Embodiment 32. The filter assembly of any one of embodiments 23-31 and 33-40, wherein at least one of the chemical filter elements comprises a chemisorbent coated substrate.

Embodiment 33. The filter assembly of any one of embodiments 23-32 and 34-40, wherein a first chemical filter element of the plurality of chemical filter elements comprises an adsorbent impregnated with a base.

Embodiment 34. The filter assembly of any one of embodiments 23-33 and 35-40, wherein a second chemical filter element of the plurality of chemical filter elements comprises an acid impregnated adsorbent, wherein the second chemical filter element is downstream of the first chemical filter element.

Embodiment 35. The filter assembly of any one of embodiments 23-34 and 36-40, wherein a first chemical filter element of the plurality of chemical filter element comprises an acid impregnated adsorbent.

Embodiment 36. The filter assembly of any one of embodiments 23-35 and 37-40, wherein a second chemical filter element comprises an adsorbent impregnated with a base, wherein the second chemical filter element is downstream of the first chemical filter element.

Embodiment 37. The filter assembly of any one of embodiments 23-36 and 38-40, wherein the plurality of chemical filter elements further comprises a third chemical filter element downstream of the second chemical filter element.

Embodiment 38. The filter assembly of any one of embodiments 23-37 and 39-40, wherein the plurality of chemical filter elements further comprises a fourth chemical filter element comprising a mesoporous absorbent, wherein the fourth chemical filter element is downstream of the third chemical filter element.

Embodiment 39. The filter assembly of any one of embodiments 23-38 and 40, wherein the plurality of chemical filter elements further comprises a fifth chemical filter element downstream of the fourth chemical filter element.

Embodiment 40. The filter assembly of any one of embodiments 23-39, wherein the first edge is opposite the second edge of the first sheet of chemical filter material.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

1. A filter assembly comprising:
a housing;
a first chemical filter element comprising a first sheet of a first chemical filter material having a first edge and a second edge, wherein a first filtration flow path is defined parallel to a surface of the first sheet and the first filtration flow path extends from the first edge to the second edge; and
a second chemical filter element comprising a second sheet of a second chemical filter material having a first edge and a second edge, wherein a second filtration flow path is defined parallel to a surface of the second sheet and the second filtration flow path extends from the first edge to the second edge, wherein the first chemical filter element and the second chemical filter element are disposed in the housing and the second chemical filter element is positioned downstream of the first chemical filter element.

2. The filter assembly of claim 1, further comprising a spacing region between the first chemical filter element and the second chemical filter element, wherein the spacing region defines a flow pathway from the first chemical filter element to the second chemical filter element.

3. The filter assembly of claim 2, further comprising a particle filter disposed in the spacing region, wherein the particle filter comprises particle filtration media and the flow pathway extends through the particle filtration media.

4. The filter assembly of claim 1, wherein the first chemical filter element further comprises a stack of a plurality of layers of sheets of the first chemical filter material including the first sheet, wherein the first filtration flow path is defined between adjacent layers in the stack.

5. The filter assembly of claim 1, wherein the first chemical filter element further comprising a stack of a plurality of flow channel layers defining the first filtration flow path, wherein each flow channel layer is disposed between and abuts layers of sheets of the first chemical filter material in the stack.

6. The filter assembly of claim 1, wherein the first sheet of the first chemical filter material is in a coiled configuration about a central axis.

7. The filter assembly of claim 6, wherein the first chemical filter element further comprises a flow channel layer abutting the first sheet of the first chemical filter material, wherein the flow channel layer defines the first filtration flow path, and the flow channel layer is in a coiled configuration about the central axis.

8. The filter assembly of claim 1, wherein the first sheet of the first chemical filter material has embossments extending between the first edge and the second edge.

9. The filter assembly of claim 1, wherein the first sheet of the first chemical filter material has one more holes extending entirely through the first sheet of the first chemical filter material.

10. The filter assembly of claim 1, a third chemical filter element comprising a third sheet of a third chemical filter material having a first edge and a second edge, wherein a third filtration flow path is defined parallel to a surface of the third sheet and the third filtration flow path extends from the first edge to the second edge.

11. The filter assembly of claim 10, further comprising a spacing region defining a flow pathway from the second chemical filter element to the third chemical filter element.

12. The filter assembly of claim 1, wherein the first chemical filter material comprises an adsorbent impregnated with a base.

13. The filter assembly of claim 1, wherein the first chemical filter material comprises an acid impregnated adsorbent.

14. The filter assembly of claim 1, wherein the second chemical filter material comprises an acid impregnated adsorbent.

15. The filter assembly of claim 1, wherein the second chemical filter material comprises an adsorbent impregnated with a base.

16. The filter assembly of claim 1, wherein the first edge is opposite the second edge of the first sheet of chemical filter material.

17. The filter assembly of claim 10, a fourth chemical filter element comprising a fourth sheet of a fourth chemical filter material having a first edge and a second edge, wherein a fourth filtration flow path is defined parallel to a surface of the fourth sheet and the fourth filtration flow path extends from the first edge to the second edge.

18. (canceled)

19. The filter assembly of claim 17, wherein the fourth chemical filter material comprises a mesoporous absorbent.

20-21. (canceled)

22. The filter assembly of claim 1, wherein the first chemical filter material comprises a chemisorbent coated substrate.

23. A filter assembly comprising:
a housing defining an inlet and an outlet;
a plurality of chemical filter elements within the housing arranged in a series with respect to fluid flow from the inlet to the outlet; and
a spacing region between adjacent filter elements in the series.

24-40. (canceled)
